(19) United States
(12) Patent Application Publication
(10) Pub. No.: US 2015/0017531 A1
(43) Pub. Date: Jan. 15, 2015

(54) BINDER COMPOSITION FOR RECHARGEABLE LITHIUM BATTERY, AND NEGATIVE ELECTRODE AND RECHARGEABLE LITHIUM BATTERY INCLUDING THE SAME

(71) Applicant: SAMSUNG SDI CO., LTD., Yongin-si (KR)

(72) Inventors: Byung-Joo CHUNG, Yongin-si (KR); Eon-Mi LEE, Yongin-si (KR)

(73) Assignee: SAMSUNG SDI CO., LTD., Yongin-si (KR)

(21) Appl. No.: 14/277,983

(22) Filed: May 15, 2014

(30) Foreign Application Priority Data
Jul. 9, 2013 (KR) 10-2013-0080553

(51) Int. Cl. H01M 4/62; H01M 4/38; H01M 10/0525; H01M 4/583; H01M 4/587; C08F 120/06; H01M 4/36

(52) U.S. Cl. CPC H01M 4/622; C08F 120/06; H01M 4/623; H01M 4/386; H01M 4/362; H01M 4/387; H01M 4/381; H01M 4/583; H01M 4/587; H01M 10/0525; H01M 2004/027
USPC 429/217; 525/329.9

(57) ABSTRACT

A binder composition for a rechargeable lithium battery includes a polyacrylic acid compound substituted with a halogen ion and a trivalent or quadrivalent metal ion.

### CROSS-REFERENCE TO RELATED APPLICATION

Korean Patent Application No. 10-2013-0080553, filed on Jul. 9, 2013, in the Korean Intellectual Property Office, and entitled: “Binder Composition For Rechargeable Lithium Battery, and Negative Electrode and Rechargeable Lithium Battery Including Same,” is incorporated by reference herein in its entirety.

### BACKGROUND

1. Field

Embodiments relate to a binder composition for a rechargeable lithium battery, and a negative electrode and a rechargeable lithium battery including the same.

2. Description of the Related Art

As portable electronic and communication devices such as video cameras, portable phones, and laptops are down-sized and made lighter, it is desirable that a battery used as a power source is not only down-sized and made lighter, but also has high energy density. A rechargeable lithium battery uses an organic electrolyte solution to obtain a high discharge voltage that is two or more times that of a battery using an alkali solution electrolyte. Thereby, a rechargeable lithium battery obtains a high energy density. Accordingly, the rechargeable lithium battery is advantageous for its small size, light weight, and high-capacity charge and discharge.

### SUMMARY

Embodiments are directed to a binder composition that includes a polyacrylic acid compound substituted with a halogen ion and a trivalent or quadrivalent metal ion.

The trivalent or quadrivalent metal ion may be an aluminum (Al) ion, a silicon (Si) ion, a manganese (Mn) ion, or a germanium (Ge) ion.

The halogen ion may be a fluorine (F) ion, a chlorine (Cl) ion, or a combination thereof.

A weight average molecular weight (Mw) of the polyacrylic acid compound may be from about 1,000 to about 1,000,000.

The polyacrylic acid compound may include a repeated unit of Chemical Formulas 1 or 2.

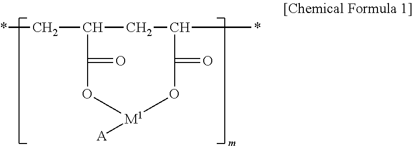

In Chemical Formula 1, M¹ is the trivalent metal ion, A is the halogen ion, and m is an integer of 1 or more.

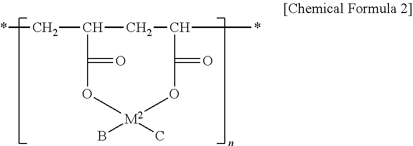

In Chemical Formula 2, M² is the quadrivalent metal ion, B and C are independently halogen ions, and n is an integer of 1 or more.

The polyacrylic acid compound may include the repeated unit of Chemical Formula 1, and M¹ may be aluminum (Al).

The polyacrylic acid compound may include the repeated unit of Chemical Formula 2, and M² may be silicon (Si).

In Chemical Formulas 1 and 2, A, B, and C may be independently a fluorine (F) ion, a chlorine (Cl) ion, or a combination thereof.

Embodiments are also directed to a negative electrode for a rechargeable lithium battery that includes a current collector and a negative active material layer formed on the current collector. The negative active material layer includes a negative active material and a binder composition including a polyacrylic acid compound substituted with a halogen ion and a trivalent or quadrivalent metal ion and.

The negative active material may include a Si-based compound selected from Si, SiOₓ (0<x<2), a Si—Y¹ alloy or a combination thereof (Y¹ is an alkali metal, an alkali earth metal, a group 13 element, a group 14 element, a transition metal, a rare earth element, or a combination thereof, but is not Si), a Si—C composite, or a combination thereof), or a Sn-based compound selected from Sn, SnO₂, Sn—Y² or a combination thereof (Y² is an alkali metal, an alkali earth metal, a group 13 element, a group 14 element, a transition metal, a rare earth element, or a combination thereof, but is not Sn), or a combination thereof.

An amount of the binder composition may be about 1 wt % to about 50 wt % based on the entire negative active material layer.

The Si-based compound, the Sn-based compound, or the combination thereof may be included at 10 wt % to 90 wt % compared with the entire negative active material.

The trivalent or quadrivalent metal ion may be an aluminum (Al) ion, a silicon (Si) ion, a manganese (Mn) ion, or a germanium (Ge) ion.

The halogen ion may be a fluorine (F) ion, a chlorine (Cl) ion, or a combination thereof.

A weight average molecular weight (Mw) of the polyacrylic acid compound may be from about 1,000 to about 1,000,000.

The polyacrylic acid compound may include a repeated unit of Chemical Formula 1 or 2.

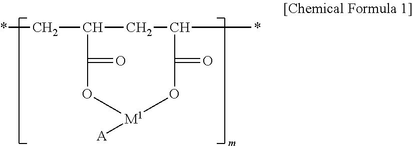

In Chemical Formula 1, M¹ is the trivalent metal ion, A is the halogen ion, and m is an integer of 1 or more.

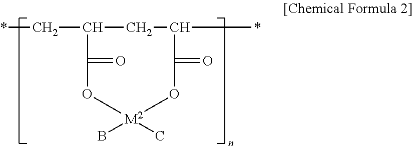

In Chemical Formula 2, M² is the quadrivalent metal ion, B and C are independently halogen ions, and n is an integer of 1 or more.

The polyacrylic acid compound may include the repeated unit of Chemical Formula 1, and M¹ may be aluminum (Al).

The polyacrylic acid compound may include the repeated unit of Chemical Formula 2, and M² may be silicon (Si).

In Chemical Formulas 1 and 2, A, B, and C may independently be the fluorine (F) ion, the chlorine (Cl) ion, or the combination thereof.

A rechargeable lithium battery including a positive electrode, the negative electrode, and an electrolyte solution.

### BRIEF DESCRIPTION OF THE DRAWING

Features will become apparent to those of skill in the art by describing in detail exemplary embodiments with reference to the attached drawing in which:

FIG. 1 illustrates a schematic diagram of a rechargeable lithium battery an exemplary embodiment.

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing FIGURE, the dimensions of features may be exaggerated for clarity of illustration.

A binder composition for a rechargeable lithium battery according to an exemplary embodiment includes a polyacrylic acid (PAA) compound that is substituted with a trivalent or quadrivalent metal ion and a halogen ion.

The substituted polyacrylic acid compound may be obtained by substituting a hydrogen (H) ion of carboxyl groups (—COOH) positioned at an end of the polyacrylic acid with the trivalent or quadrivalent metal ion and again substituting the hydrogen ion existing in the obtained compound with the halogen ion.

Halogen ion may hop in the binder including the substituted polyacrylic acid, i.e., reformed polyacrylic acid compound, during the charge and discharge such that battery performance may be improved.

The trivalent or quadrivalent metal ion may include any suitable metal with 3 or 4 valence electrons. For example, the metal may include a transition metal, a post-transition metal, or a semi-metal.

The trivalent or quadrivalent metal ion may be an aluminum (Al) ion, a silicon (Si) ion, a manganese (Mn) ion, or a germanium (Ge) ion.

The trivalent metal ion may be an aluminum (Al) ion, for example.

The quadrivalent metal ion may be a silicon (Si) ion, for example.

The halogen ion may be, for example, a fluorine (F) ion, a chlorine (Cl) ion, or a combination thereof. These halogen ions may exhibit an excellent hopping characteristic such that the battery performance may be improved.

The halogen ion may be, for example, a fluorine (F) ion. In this case, as fluorine hops in the negative active material, fluorine may be primarily bonded with Si of the Si-based active material such that a structure thereof may be strong. The binder may have a characteristic that it does not absorb Li such that Li ions may migrate well into a side of the negative electrode, thereby improving battery performance.

A weight average molecular weight (Mw) of the polyacrylic acid compound may be in a range from about 1,000 to about 1,000,000. When the weight average molecular weight (Mw) falls within this range, a cycle-life characteristic of the battery may be more improved. As an example, the weight average molecular weight (Mw) may be in a range from about 100,000 to about 1,000,000.

The polyacrylic acid compound may include a repeated unit of Chemical Formula 1 or 2.

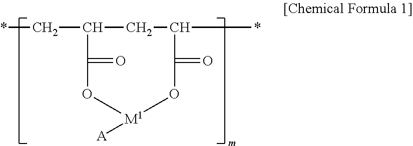

In Chemical Formula 1, M¹ is a trivalent metal ion, A is a halogen ion, and m is an integer of 1 or more than.

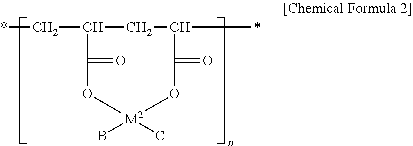

In Chemical Formula 2, M² is a quadrivalent metal ion, B and C are independently halogen ions, and n is an integer 1 or more than.

The polyacrylic acid compound may include a compound of Chemical Formula 1, Chemical Formula 2, or a combination of Chemical Formula 1 and Chemical Formula 2.

In Chemical Formula 1, the trivalent metal ion may include any suitable metal with 3 valence electrons. The metal may be, for example, a transition metal, a post-transition metal, or the semi-metal. For example, the trivalent metal ion may be an aluminum (Al) ion.

In Chemical Formula 2, the quadrivalent metal ion may be any suitable metal with 4 valence electrons. The metal may be, for example, a transition metal, the post-transition metal, or a semi-metal. For example, the quadrivalent metal ion may be a silicon (Si) ion.

In Chemical Formulae 1 and 2, A, B, and C may independently be a fluorine (F) ion, a chlorine (Cl) ion, or a combination thereof.

Another embodiment is directed to a current collector and a negative active material layer formed on the current collector. The negative active material layer may include a negative active material, and a binder composition including the polyacrylic acid compound that is substituted with the trivalent or quadrivalent metal ion and the halogen ion.

The negative active material may include a Si-based compound selected from Si, SiOₓ (0<x<2), a Si—Y¹ alloy (Y¹ is an alkali metal, an alkali earth metal, a group 13 elements, a group 14 element, a transition metal, a rare earth element, or a combination thereof, and is not Si), a Si—C composite, or of the combination thereof; a Sn-based compound selected from Sn, SnO₂, Sn—Y² (Y² is an alkali metal, an alkali earth metal, a group 13 element, a group 14 element, a transition metal, a rare earth element, or a combination thereof, and is not Sn), or a combination thereof; or a combination thereof. In this case, the capacity characteristic of the battery may be improved.

In the negative active material, Y¹ or Y² may include, for example, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ni, Ge, P, As, Sb, Bi, S, Se, Te, Po, or a combination thereof. For example, the negative active material may be a Si-alloy including Ni, or Ti.

The binder composition is the same as that described above such that an overlapping description will not be repeated here.

When the binder composition is used in the negative electrode including the Si-based negative active material, expansion of Si may be effectively controlled. Upon the charge and discharge of the rechargeable battery, the substituted metal ion and the halogen ion included in the binder composition may hop such that the performance of the battery may be improved. Also, the binder composition may include an octahedral coordinate bond that is formed with the substituted metal ion at its center such that a predetermined space is formed. The space may function as a buffer layer. Accordingly, the battery including the binder composition may have a stable cycle-life characteristic while having high efficiency when the Si-based active material is used as the negative active material.

The amount of the binder composition may be about 1 wt % to about 50 wt % based on the entire negative active material layer. When the amount of the binder composition falls within this range, the performance of the battery may be improved. For example, the amount of the binder composition may be about 4 wt % to about 15 wt %.

According to another embodiment, a rechargeable lithium battery including the binder composition is provided.

The rechargeable lithium battery may be classified as a lithium ion battery, a lithium ion polymer battery, or a lithium polymer battery according to the kind of separator used and electrolyte used, as a cylindrical type, a prismatic type, a coin type, or a pouch type according to a shape, and as a bulk type or a thin film type according to a size.

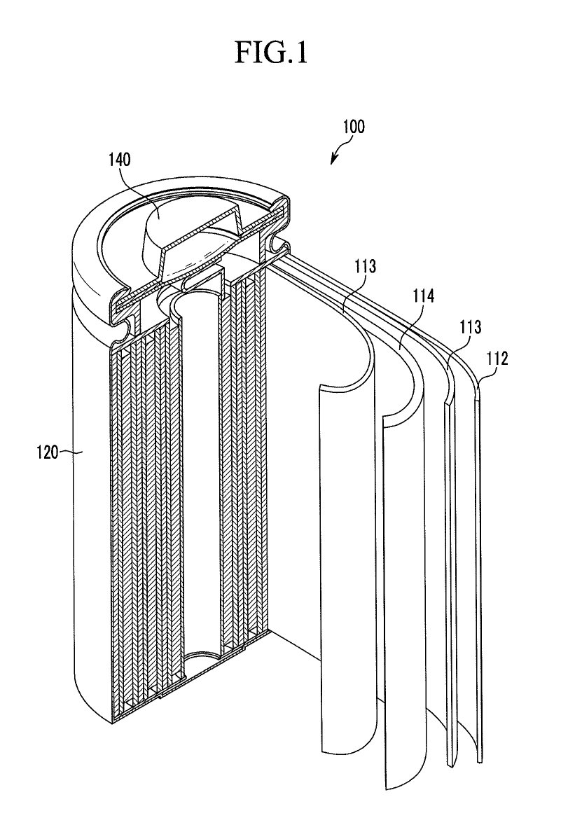

FIG. 1 illustrates a representative structure of the rechargeable lithium battery. As shown in FIG. 1, the rechargeable lithium battery 100 may be a cylindrical type that includes a negative electrode 112, a positive electrode 114 and a separator 113 disposed between the negative electrode 112 and the positive electrode 114, an electrolyte solution (not shown) impregnated to the negative electrode 112, the positive electrode 114, and the separator 113, a battery container 120, and a sealing member 140 sealing the battery case 120, as main components. The rechargeable lithium battery 100 may be formed by sequentially stacking the negative electrode 112, the separator 113, and the positive electrode 114, spiral-winding them and, inserting them into the battery case 120.

The negative electrode 112 may include the current collector and the negative active material layer formed on the current collector. The negative active material layer may include the negative active material and the binder.

As the current collector, a copper foil, a nickel foil, a stainless steel foil, a titanium foil, a nickel foam, a copper foam, or a polymer material coated with a conductive metal, or a combination thereof, may be used, as examples.

The negative active material may include a material that reversibly intercalates/deintercalates lithium ions, a lithium metal, a lithium metal alloy, a material being capable of doping and dedoping lithium, or a transition metal oxide.

The material that reversibly intercalates/deintercalates lithium ions may be a carbon material, such as a carbon-based negative active material suitable for use in a rechargeable lithium ion battery. Examples of the carbon material include crystalline carbon, amorphous carbon, or a combination thereof. Examples of the crystalline carbon include a graphite such as a shapeless, sheet-shaped, flake, spherical shaped or fiber-shaped natural graphite or artificial graphite. Examples of the amorphous carbon include soft carbon, hard carbon, a mesophase pitch carbonized product, fired cokes, or the like.

The alloy of the lithium metal may be a metal alloy of lithium and may be selected from a group of Na, K, Rb, Cs, Fr, Be, Mg, Ca, Sr, Si, Sb, Pb, In, Zn, Ba, Ra, Ge, Al, and Sn.

The material being capable of doping and dedoping lithium may be a Si-based compound selected from Si, SiOₓ (0<x<2), a Si—C composite, a Si—Y¹ alloy (wherein Y¹ is an alkali metal, an alkaline-earth metal, a Group 13 to 16 element, a transition metal, a rare earth element, or a combination thereof, and not Si); a Sn-based compound selected from Sn, SnO₂, a Sn—C composite, Sn—Y² (wherein Y² is an alkali metal, an alkaline-earth metal, a Group 13 to 16 element, a transition metal, a rare earth element, or a combination thereof, and not Sn), or a combination thereof; or a combination thereof. Y¹ or Y² may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

As the transition metal oxide, a vanadium oxide or a lithium vanadium oxide may be used.

Among the negative active material, Si, SiOₓ (0<x<2), a Si—C composite, a Si—Y¹ alloy (wherein Y¹ is an alkali metal, an alkaline-earth metal, Group 13 to 16 elements, a transition metal, a rare earth element, or a combination thereof, and not Si), Sn, SnO₂, a Sn—C composite, Sn—Y² (wherein Y² is an alkali metal, an alkaline-earth metal, a Group 13 to 16 element, a transition metal, a rare earth element, or a combination thereof, and not Sn), and the like, may be used.

For example, the Si-based compound, the Sn-based compound, or the combination thereof may be included at about 10 wt % to about 90 wt % based on the entire negative active material.

When using the Si-based compound or the Sn-based compound as the negative active material, the cycle-life characteristic could deteriorate by repeated expansion and compression of the negative active material upon charge and discharge. However, when using the binder composition according to the embodiments as the binder, the cycle-life characteristic may be remarkably improved.

As the binder, an aqueous binder using water as a solvent or a distributed medium may be used. The example of the binder composition may include the binder composition according to embodiments

The negative active material layer may further include a conductive material.

The conductive material may improve electrical conductivity of an electrode. Any suitable electrically conductive material that does not cause chemical change may be used as a conductive material. Examples thereof include a carbon-based material such as natural graphite, artificial graphite, carbon black, acetylene black, ketjen black, a carbon fiber, or the like; a metal-based material, such as a metal powder or a metal fiber or the like, of copper, nickel, aluminum, silver, or the like; a conductive polymer such as a polyphenylene derivative or the like; or a mixture thereof.

The positive electrode 114 may include a current collector and a positive active material layer formed at the current collector. The positive active material layer may include a positive active material and binder.

Al may be used as the current collector, as an example.

The positive active material may include a lithiated intercalation compound that reversibly intercalate and deintercalate lithium ions. For example, at least one lithium metal composite oxide of lithium and a metal of cobalt, manganese, nickel, or a combination thereof may be used. Specific examples thereof include compounds represented by the following chemical formulae.

LiₐA_{1-b}R_{b}D₂ (0.90≦a≦1.8 and 0≦b≦0.5); LiₐE_{1-b}R_{b}O_{2-c}D_{c} (0.90≦a≦1.8, 0≦b≦0.5, and 0≦c≦0.05); LiE_{2-b}R_{b}O_{4-c}D_{c} (0≦b≦0.5 and 0≦c≦0.05); LiₐNi_{1-b-c}Co_{b}R_{c}D_{α} (0.90≦a≦1.8, 0≦b≦0.5, 0≦c≦0.05, and 0<α≦2); LiₐNi_{1-b-c}Co_{b}R_{c}O_{2-α}Z_{α} (0.90≦a≦1.8, 0≦b≦0.5, 0≦c≦0.05, and 0<α<2); LiₐNi_{1-b-β}Co_{b}R_{c}O_{2-α}Z₂ (0.90≦a≦1.8, 0≦b≦0.5, 0≦c≦0.05, and 0<α<2); LiₐNi_{1-b-β}Mn_{b}R_{c}D_{α} (0.90≦a≦1.8, 0≦b≦0.5, 0≦c≦0.05, and 0<α≦2); LiₐNi_{1-b-β}Mn_{b}R_{c}O_{2-α}Z_{α} (0.90≦a≦1.8, 0≦b≦0.5, 0≦c≦0.05, and 0<α<2); LiₐNi_{1-b-β}Mn_{b}R_{c}O_{2-α}Z₂ (0.90≦a≦1.8, 0≦b≦0.5, 0≦c≦0.05, and 0<α<2); LiₐNi_{b}E_{c}G_{d}O₂ (0.90≦a≦1.8, 0≦b≦0.9, 0≦c≦0.5, and 0.001≦d≦0.1); LiₐNi_{b}Co_{c}Mn_{d}GeO₂ (0.90≦a≦1.8, 0≦b≦0.9, 0≦c≦0.5, 0≦d≦0.5, and 0.001≦e≦0.1); LiₐNiG_{b}O₂ (0.90≦a≦1.8 and 0.001≦b≦0.1); LiₐCoG_{b}O₂ (0.90≦a≦1.8 and 0.001≦b≦0.1); LiₐMnG_{b}O₂ (0.90≦a≦1.8 and 0.001≦b≦0.1); LiₐMn₂G_{b}O₄ (0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃ (0≦f≦2); Li_{(3-f)}Fe₂(PO₄)₃ (0≦f≦2); and LiFePO₄.

In the above chemical formulae, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

The positive active material may include the positive active material with a coating layer, or a compound of the active material and the active material coated a coating layer. The coating layer may include a coating element, a compound of an oxide of a coating element, a hydroxide of a coating element, an oxyhydroxide of a coating element, an oxycarbonate of a coating element, or a hydroxycarbonate of a coating element. The compound for the coating layer may be either amorphous or crystalline. The coating element included in the coating layer may be Mg, Al, Co, K, Na, Ca, Si, Ti, V, Sn, Ge, Ga, B, As, Zr, or a mixture thereof. The coating process may include any suitable process (e.g., spray coating, dipping) that does not cause side effects to the properties of the positive active material.

The binder of the positive active material layer may include an organic binder that is dissolved or dispersed in an organic solvent such as N-methylpyrrolidone (NMP), an aqueous binder using water as the solvent or the dispersed medium, or a combination thereof.

The organic binder may be polyvinylidene fluoride (PVDF), a polyimide, a polyamide, or a combination thereof, as examples.

The aqueous binder may be polyvinyl alcohol, carboxymethyl cellulose, hydroxypropyl cellulose, polyvinyl chloride, carboxylated polyvinyl chloride, polyvinyl fluoride, a polymer including ethylene oxide, polyvinyl pyrrolidone, polyurethanes, polytetrafluoroethylene, polyvinylidene fluoride, polyethylene, polypropylene, styrene butadiene rubber, acrylated styrene-butadiene rubber, an epoxy resin, nylon, or the like may be used, as examples.

The positive active material layer may include a conductive material.

The conductive material improves electrical conductivity of an electrode. Any electrically conductive material that does not cause chemical change may be used. Examples thereof include natural graphite, artificial graphite, carbon black, acetylene black, ketjen black, carbon fiber, copper, nickel, aluminum, silver, or the like, a metal powder, a metal fiber, or the like. One or more kinds of a conductive material such as a polyphenylene derivative or the like may be mixed.

The negative electrode 112 and the positive electrode 114 may be manufactured by mixing an active material, a conductive material, and a binder in a solvent to prepare an active material composition, and coating the composition on a current collector. The solvent may include N-methylpyrrolidone or the like.

The electrolyte may include a non-aqueous organic solvent and a lithium salt.

The lithium salt may be dissolved in an organic solvent, may supply lithium ions in a battery, may operate a basic operation of the rechargeable lithium battery, and may improve lithium ion transportation between positive and negative electrodes therein.

Examples of the lithium salt include LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂), wherein, x and y are natural numbers, LiCl, LiI, LiB(C₂O₄)₂ (lithium bis(oxalato) borate; LiBOB) or a combination thereof, which is used as a supporting electrolytic salt. The lithium salt may be used in a concentration ranging from about 0.1 M to about 2.0 M. When the lithium salt is included at the above concentration range, an electrolyte may have excellent performance and lithium ion mobility due to optimal electrolyte conductivity and viscosity.

The non-aqueous organic solvent may function as a medium through which ions participating in an electrochemical reaction of a battery may move.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like.

Particularly, when a mixture of a cyclic-type carbonate and a chain-type carbonate is used, a dielectric constant may be increased and viscosity may be simultaneously decreased. The cyclic carbonate and the linear carbonate may be mixed together in the volume ratio of about 1:1 to about 1:9.

The ester-based solvent may include methyl acetate, ethyl acetate, n-propyl acetate, dimethylethyl acetate, methylpropionate, ethylpropionate, γ-butyrolactone, decanolide, valerolactone, mevalonolactone, caprolactone, and the like. The ether-based solvent may include dibutyl ether, tetraglyme, diglyme, dimethoxyethane, 2-methyltetrahydrofuran, tetrahydrofuran, or the like, and the ketone-based solvent may include cyclohexanone, or the like. The alcohol-based solvent may include ethanol, isopropyl alcohol, or the like, and the aprotic solvent may include a nitrile such as R—CN (R is a hydrocarbon group having a C2 to C20 linear, branched, or cyclic structure, and may include a double bond, an aromatic ring, or an ether bond) or the like, an amide such as dimethylformamide or the like, or a dioxolane such as 1,3-dioxolane or the like, or a sulfolane, or the like.

The non-aqueous organic solvent may be used singularly or in a mixture. When the organic solvent is used in a mixture, the mixture ratio may be controlled in accordance with a desirable battery performance.

The non-aqueous electrolyte solution may further include additives such as an overcharge preventing agent of ethylene carbonate, or pyrocarbonate.

The separator 113 may be a single-layered film of polyethylene, polypropylene, or polyvinylidene fluoride, a multi-layered film formed of two or more thereof, a mixed multilayer of a two-layered separator of polyethylene/polypropylene, or a three-layered separator of polyethylene/polypropylene/polyethylene or polypropylene/polyethylene/polypropylene, as examples.

The following Examples and Comparative Examples are provided in order to highlight characteristics of one or more embodiments, but it is to be understood that the Examples and Comparative Examples are not to be construed as limiting the scope of the embodiments, nor are the Comparative Examples to be construed as being outside the scope of the embodiments. Further, it is to be understood that the embodiments are not limited to the particular details described in the Examples and Comparative Examples.

### Preparation of Binder

### Comparative Synthesis Example 1

PAA (polyacrylic acid, from Sigma-Aldrich Co., viscosity average molecular weight (Mv)=450,000) powder was weighed in order to reach 7 wt % in deionized (DI) water and was added to DI water, and then was dissolved at 40° C. to prepare a binder including PAA represented by Chemical Formula a.

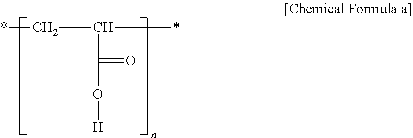

(viscosity average molecular weight=450,000)

### Synthesis Example 1

730 g of deionized water and 70 g of PAA (polyacrylic acid, from Sigma-Aldrich Co., Mv=450,000) were added to a 1 L reaction bath equipped with a heater, a cooler, and a mixer, and were completely dissolved at 40° C. to prepare a PAA solution. 30.01 g of ANNH (aluminum nitrate nonahydrate, from Sigma-Aldrich Co.) was added to 100 g of deionized water and was completely dissolved. Also, 0.0045 g of ADH (ammonium hydrogen difluoride, from Sigma-Aldrich Co.) was added to 100 g of deionized water and was dissolved. The ADH solution was dripped into the ANNH solution for about 1 hour and the obtained solution was continuously agitated for 3 to 5 hours. This obtained solution was then dripped into the PAA solution during a period of 1 hour. After the dripping, the resultant was agitated for 12 hours to prepare the binder including the FPAA represented by Chemical Formula b below. Viscosity of the resulting binder was about 8000 cps.

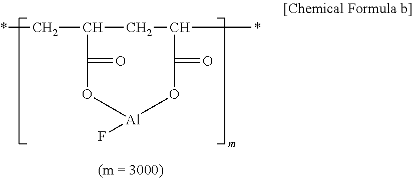

### Synthesis Example 2

730 g of deionized water and 70 g of PAA (polyacrylic acid, from Sigma-Aldrich Co., Mv=450,000) were added to a 1 L reaction bath equipped with a heater, a cooler, and a mixer, and were completely dissolved at 40° C. to prepare a PAA solution. 0.0167 g of TEOS (tetraethyl orthosilicate, from Sigma-Aldrich Co.) was added to 100 g of deionized water and was completely dissolved to prepare a TEOS solution. Also, 0.0045 g of ADH (ammonium hydrogen difluoride, from Sigma-Aldrich Co.) was added to 100 g of deionized water and was completely dissolved to prepare an ADH solution. The ADH solution was dripped into the TEOS solution for about 1 hour and the obtained solution was continuously agitated for 3 to 5 hours. This obtained solution was dripped into the PAA solution during a period of 1 hour. After the dripping, the obtained product was agitated for 12 hours to prepare a binder including the FPAA represented by Chemical Formula c below. Viscosity of the manufactured binder is about 7000 cps.

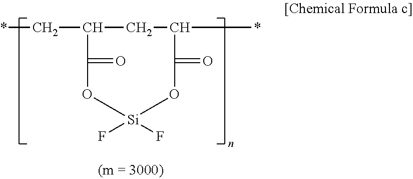

### Manufacturing a Rechargeable Lithium Battery

### Example 1

As the negative active material, “SiNW16” (27.6 wt %) and a graphite “MAGV4” (64.4 wt %) were mixed and then the binder (8 wt %) prepared by the Synthesis Example 1 was added thereto, thereby preparing a slurry. Here, SiNW16 has a structure in which silicon nanowires are grown on the graphite. The slurry was coated onto a copper foil and dried at 110° C., and then was pressed to prepare the negative electrode.

A positive electrode including an NCM622 (LiNi_{0.6}CO_{0.2}Mn_{0.2}O₂) positive active material, and a polypropylene separator were used. The counter electrode was prepared by using the active material, the conductive material (Denka black), and the binder (PVdF) at a ratio of 94:3:3. As an electrolyte solution, an electrolyte including LiPF₆ at a 1.5 M/L concentration added to a mixture of ethylene carbonate (EC), diethyl carbonate (DEC), and fluorine ethylene carbonate (FEC) at a ratio of 5:70:25 was used along with the positive electrode and the negative electrode to manufacture the rechargeable lithium battery.

### Example 2

The rechargeable lithium battery is manufactured by the same method as Example Embodiment 1, except for using the binder manufactured by Synthesis Example 2 in the negative electrode.

### Example 3

A rechargeable lithium battery was fabricated by the same procedure as in Example 1 except that as the negative active material, a mixture of “STN” (Si:Ti:Ni=68:16:16) (80 wt %) and the graphite “MAGV4” (10 wt %) was used and the binder (8 wt %) prepared according to Synthesis Example 1 and KB600 (Ketjen Black International Company, 2 wt %) as the conductive material were used.

### Example 4

A rechargeable lithium battery was fabricated by the same method as Example 3, except for using the binder according to Synthesis Example 2 in the negative electrode.

### Comparative Example 1

A rechargeable lithium battery was fabricated by the same method as Example 1, except for using the binder according to Comparative Synthesis Example 1 in the negative electrode.

### Comparative Example 2

A rechargeable lithium battery was manufactured by the same method as Example 3, except for using the binder according to Comparative Synthesis Example 1 in the negative electrode.

<Characteristic Estimation of a Rechargeable Lithium Battery>

For the rechargeable lithium battery according to Examples 1 to 4, and Comparative Examples 1 to 2, compositions of the negative active material and the binder, a capacity characteristic, a cycle-life characteristic, initial efficiency, and adherence were measured. The results are shown in Tables 1 and 2.

TABLE 1

| | | | | Comparative |
|---|---|---|---|---|
| | | Example 11 | Example 2 | Example 1 |
| Active material | SiNW (wt %) | 27.6 | 27.6 | 27.6 |
| | Graphite | 64.4 | 64.4 | 64.4 |
| | (wt %) | | | |
| Conductive material (wt %) | | — | — | — |
| Binder | SBR | | | |
| (wt %) | CMC | | | |
| | FPAA trivalent | 8 | | |
| | FPAA | | 8 | |
| | quadrivalent | | | |
| | PAA | | | 8 |
| Initial | | 86 | 90 | 84 |
| efficiency | | | | |
| (%) | | | | |
| Retention | | 82 | 86 | 72 |
| capacity (%) | | | | |
| after 100th | | | | |
| cycle | | | | |

TABLE 2

| | | | | Comparative |
|---|---|---|---|---|
| | | Example 3 | Example 4 | Example 2 |
| Active | Alloy (wt %) | 80 | 80 | 80 |
| material | Graphite | 10 | 10 | 10 |
| | (wt %) | | | |
| Conductive material | | 2 | 2 | 2 |
| (wt %) | | | | |
| Binder | SBR | | | |
| (wt %) | CMC | | | |
| | FPAA | 8 | | |
| | trivalent | | | |
| | FPAA | | 8 | |
| | quadrivalent | | | |
| | PAA | | | 8 |
| Initial | | 92 | 91 | 86 |
| efficiency | | | | |
| (%) | | | | |
| Retention | | 78 | 76 | 63 |
| capacity (%) | | | | |
| after 100th | | | | |
| cycle | | | | |

Estimation 1: Initial Efficiency

For the rechargeable lithium batteries according to Examples 1 to 4, and Comparative Examples 1 to 2, charge capacity and discharge capacity were determined after charge and discharge at 1C, and, a ratio of the discharge capacity to the charge capacity was calculated. The results are shown in Tables 1 and 2.

Referring to Tables 1 and 2, the batteries according to Example 1 and 2 were shown to have a higher initial efficiency than the battery according to Comparative Example 1. The batteries according to Examples 3 and 4 were shown to have a higher initial efficiency than the battery according to Comparative Example 2.

Estimation 2: Cycle-Life Characteristic

For the rechargeable lithium batteries manufactured by Exemplary Embodiment 1 to Exemplary Embodiment 4 and Comparative Examples 1 and 2, a capacity ratio was measured when performing 50 cycles compared with the 1st cycle when the charge and discharge were performed in a condition of 1C after an initial charge and discharge.

Referring to Tables 1 and 2, the batteries according to Exemplary Embodiments 1 and 2 were shown to have a higher retention capacity than the battery according to Comparative Example 1. The batteries according to Exemplary Embodiments 3 and 4 were shown to have a higher retention capacity than the battery according Comparative Example 2.

By way of summation and review, as a negative active material that is a main component of a negative electrode of the rechargeable lithium battery, a carbon-based material may have limited usefulness due to restricted capacity. Instead, a silicon (Si)-based negative active material having a high specific capacity has been used.

When preparing an electrode, a binder for an adhesive force of an active material is used. When a binder is applied to a Si-based negative active material, cycle-life characteristics of the rechargeable lithium battery may decrease suddenly. Without being bound to any particular theory, it is considered that the decrease in cycle-life characteristics may occur because the adhesive force of the binder is decreased by a volume change of Si upon the charge and discharge. Accordingly, in the case of applying a binder to the Si-based negative active material, a binder material in which the cycle-life characteristics do not deteriorate is desirable.

Embodiments provide a binder composition for a rechargeable lithium battery having electrode stability and an excellent cycle-life characteristic. Embodiments also provide a negative electrode for a rechargeable lithium battery including the binder composition. Embodiments also provide a rechargeable lithium battery including the binder composition.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope as set forth in the following claims.

What is claimed is:

1. A binder composition for a rechargeable lithium battery, the binder comprising:
a polyacrylic acid compound substituted with a halogen ion and a trivalent or quadrivalent metal ion.

2. The binder composition as claimed in claim 1, wherein
the trivalent or quadrivalent metal ion is an aluminum (Al) ion, a silicon (Si) ion, a manganese (Mn) ion, or a germanium (Ge) ion.

3. The binder composition as claimed in claim 1, wherein
the halogen ion is a fluorine (F) ion, a chlorine (Cl) ion, or a combination thereof.

4. The binder composition as claimed in claim 1, wherein
a weight average molecular weight (Mw) of the polyacrylic acid compound is from about 1,000 to about 1,000,000.

5. The binder composition as claimed in claim 1, wherein
the polyacrylic acid compound includes a repeated unit of Chemical Formula 1 or 2: 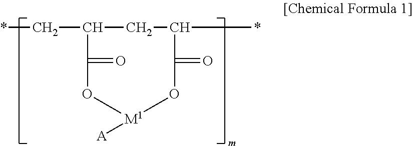
wherein, M¹ is the trivalent metal ion, A is the halogen ion, and m is an integer of 1 or more; 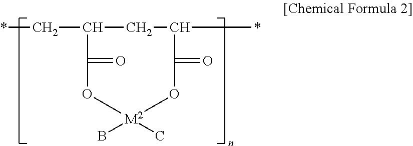
wherein, M² is the quadrivalent metal ion, B and C are independently halogen ions, and n is an integer of 1 or more.

6. The binder composition as claimed in claim 5, wherein
the polyacrylic acid compound includes the repeated unit of Chemical Formula 1, and M¹ is aluminum (Al).

7. The binder composition as claimed in claim 5, wherein
the polyacrylic acid compound includes the repeated unit of Chemical Formula 2, and
M² is silicon (Si).

8. The binder composition as claimed in claim 5, wherein
in Chemical Formulas 1 and 2, A, B, and C are independently a fluorine (F) ion, a chlorine (Cl) ion, or a combination thereof.

9. A negative electrode for a rechargeable lithium battery, the negative electrode comprising:
a current collector; and
a negative active material layer formed on the current collector,
wherein the negative active material layer includes a negative active material, and a binder composition including a polyacrylic acid compound substituted with a halogen ion and a trivalent or quadrivalent metal ion.

10. The negative electrode as claimed in claim 9, wherein
the negative active material includes: a Si-based compound selected from Si, SiOₓ (0<x<2), a Si—Y¹ alloy (Y¹ is an alkali metal, an alkali earth metal, a group 13 element, a group 14 element, a transition metal, a rare earth element, or a combination thereof, but is not Si), a Si—C composite, or a combination thereof; a Sn-based compound selected from Sn, SnO₂, Sn—Y² (Y² is an alkali metal, an alkali earth metal, a group 13 element, a group 14 element, a transition metal, a rare earth element, or a combination thereof, but is not Sn), or a combination thereof; or a combination thereof.

11. The negative electrode as claimed in claim 9, wherein
an amount of the binder composition is about 1 wt % to about 50 wt % compared with the entire negative active material layer.

12. The negative electrode as claimed in claim 10, wherein
the negative active material includes the Si-based compound, the Sn-based compound or the combination thereof in an amount of about 10 wt % to about 90 wt % based on the entire negative active material.

13. The negative electrode as claimed in claim 9, wherein
the trivalent or quadrivalent metal ion is an aluminum (Al) ion, a silicon (Si) ion, a manganese (Mn) ion, or a germanium (Ge) ion.

14. The negative electrode as claimed in claim 9, wherein
the halogen ion is a fluorine (F) ion, a chlorine (Cl) ion, or a combination thereof.

15. The negative electrode as claimed in claim 9, wherein
a weight average molecular weight (Mw) of the polyacrylic acid compound is from 1,000 to 1,000,000.

16. The negative electrode of claim 9, wherein
the polyacrylic acid compound includes a repeated unit of Chemical Formula 1 or 2: 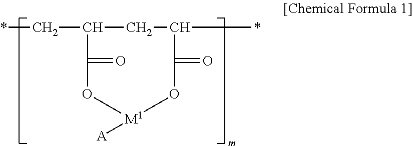
wherein, M¹ is the trivalent metal ion, A is the halogen ion, and m is an integer of 1 or more; 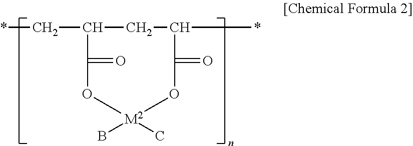
wherein, M² is the quadrivalent metal ion, B and C are independently halogen ions, and n is an integer of 1 or more.

17. The negative electrode as claimed in claim 15, wherein
the polyacrylic acid compound includes the repeated unit of Chemical Formula 1, and
M¹ is aluminum (Al).

18. The negative electrode as claimed in claim 15, wherein
the polyacrylic acid compound includes the repeated unit of Chemical Formula 2, and
M² is silicon (Si).

19. The negative electrode as claimed in claim 15, wherein
in Chemical Formulas 1 and 2, A, B, and C are independently the fluorine (F) ion, the chlorine (Cl) ion, or the combination thereof.

20. A rechargeable lithium battery comprising:
a positive electrode;
the negative electrode of claim 9; and
an electrolyte.
